(19) United States
(12) Patent Application Publication
(10) Pub. No.: US 2004/0219503 A1
(43) Pub. Date: Nov. 4, 2004

(54) System and method for linking content standards, curriculum instructions and assessment

(75) Inventor: Daniel M. Lewis, Carmel, CA (US)

Correspondence Address: ROTHWELL, FIGG, ERNST & MANBECK, P.C., 1425 K STREET, N.W., SUITE 800, WASHINGTON, DC, 20005, US

(73) Assignee: The McGraw-Hill Companies, Inc., New York, NY

(21) Appl. No.: 10/854,630

(22) Filed: May 27, 2004

Related U.S. Application Data
(63) Continuation of application No. 10/158,168, filed on May 31, 2002.
(60) Provisional application No. 60/325,228, filed on Sep. 28, 2001.

(51) Int. Cl. G09B 19/00; G09B 7/00

(52) U.S. Cl. 434/322

(57) ABSTRACT

A method of instruction and assessment includes providing in an ordered item booklet containing a set of ordered assessment items arranged by degree of difficulty and one or more cutoffs corresponding to one or more respective performance levels. Achievement of a specified performance level requires the ability to provide a correct response to substantially all of the assessment items having a degree of difficulty below a cut-off corresponding to the specified performance level. A diagnostic pretest, including at least a portion of the items from the ordered item booklet rearranged so that they are not presented in ascending order of difficulty, is administered to a student, and the pretest is scored and the student's score is correlated to a performance level. Using the ordered item booklet the student's skill set associated with the performance level is assessed and the additional skills necessary to achieve a higher performance level are identified. Based on the additional skills identified, an instructional curriculum designed to teach the student the additional skills is developed and implemented.

### CROSS-REFERENCE OF RELATED APPLICATION

This application is a continuation of Ser. No. 10/158,168 filed May 31, 2002, which claims the benefit of U.S. Provisional Application No. 60/325,228 filed Sep. 28, 2001, and is hereby incorporated by reference.

### BACKGROUND AND SUMMARY OF THE INVENTION

Because students are placed into performance levels based on their test scores, it is necessary to determine the cut scores that will correspond to the various performance levels. A cut score is the score a student must attain or exceed in order to place into the corresponding performance level. For example, many schools have used the performance levels “A-student,” “B-student,” “C-student,” “D-student,” and “F-student.” For these performance levels, the cut scores are often set at 90% (A-student), 80% (B-student), 70% (C-student), and 60% (D-student). Students who do not attain at least 60% are classified as F-students. However, using these arbitrary percentages to determine performance level placement regardless of the test being administered does not take into account the difficulty of the test or the specific knowledge, skills, and abilities required to answer the test questions.

To set meaningful cut scores, one must conduct a standard setting. Standard setting is the process of determining appropriate cut scores that correspond to a specified level of performance. The goal is to establish cut scores that are based on what students in each performance level should know and be able to do. For example, if a student obtained or exceeded the cut score corresponding to the “proficient” performance level, then that student should have demonstrated knowledge, skills, and abilities sufficient to be called “proficient.” State content standards typically indicate what it is that students should be expected to do; standard setting determines the test scores that corresponds to those expectations.

CTB/McGraw-Hill developed the Bookmark™ standard setting procedure in response to the national movement toward standards-based education and the controversy within the community of educational and measurement professionals regarding existing standard setting procedures. Although there is still controversy, the Bookmark™ procedure has become widely implemented across the country.

The Bookmark™ procedure is performed using ordered item booklets. The ordered item booklets are created by taking the original test items from the assessment and rearranging them according to difficulty, as measured by actual student data. That is, the easiest item is placed on the first page of the booklet followed by the next more difficult item on the second page, and so on, with the hardest item appearing on the last page of the ordered item booklet. Alternatively, although less preferred, the items could be arranged in descending order of difficulty. In creating the ordered item booklets, the original test pages are reproduced and rearranged, so that there may actually be more than one item on each page of the ordered item booklet. The appropriate item (i.e., the ordered item) for study is indicated by placing a black box around it, and the other item(s) on the page can be ignored. A sample of a test page from an ordered item booklet of the type used in the Bookmark™ procedure is shown in FIG. 1. In FIG. 1, item number “7” is the ordered item and item number 6, at least insofar as the page shown in FIG. 1, can be ignored.

The participants use the ordered item booklets in two ways during the Bookmark™ standard setting process.

First, they use the ordered item booklets as part of a series of exercises intended to familiarize the participants with the test items and the knowledge, skills, and abilities students must hold in order to be successful on the assessment. To accomplish this, participants work in small groups, studying the items one at time. By studying the items, we mean they respond to the item, and attempt to answer two questions: “What is the item measuring?” and “Why is the item more difficult than items that precede it in the ordered item booklet?” There are many factors that contribute to the difficulty of an item. It is hoped that the natural increase in complexity of the content as dictated by the domain of study is the primary factor contributing to an item's difficulty. For example, in elementary school mathematics, one would expect, on average, that single digit multiplication would be more challenging than single digit addition. However, there are other factors that play a role as well. For instance, when a state's curriculum is not well aligned with the state's content standards, certain topics that are tested may not yet be taught, or they may be assessed in a different manner than they are taught. Thus, the order of difficulty assessment may highlight such misalignments between curriculum and content standards.

The second use of the ordered item booklets during the standard setting procedure is to allow participants to make their judgments as to how much (i.e., up to which ordered test item) of the test content students should master in order to be considered partially proficient, proficient, or advanced (the names of performance levels vary from state to state). More specifically, participants determine the cutoff points in the ordered item booklet corresponding to the performance levels. For example, participants will determine the cutoff point for “proficient” such that, from the participants' perspectives, a student who has mastered the content reflected by the ordered items up to the cutoff point have demonstrated sufficient knowledge, skills, and abilities to infer that the student is proficient.

While the Bookmark™ process has proven to be an effective method for determining cut scores for an assessment, it is only available to a few participants under confidential conditions because of the need to prevent disclosure of test items that may appear on later tests. Heretofore, the information gained during the Bookmark™ procedure has been used primarily to determine cut scores for a particular assessment. The Applicant has discovered a system and method that uses elements of the Bookmark™ procedure, in particular the insights attained by studying ordered item booklets, to link content standards, curriculum, instruction and assessment.

The system and method of the present invention helps state departments of education meet the following challenges to public relations and educational goals:

Communicating how and what the state test measures to stakeholders (parents, teachers, students, school administrators, the business community, etc.);

Communicating to stakeholders the meaning and nature of the performance levels set on a state assessment through a state sponsored standard setting process; and

Supporting teachers with useful tools in their mission to foster student growth as measured by the state test and performance levels.

In accordance with a preferred embodiment of the present invention, two primary sets of materials are provided that will support the sponsoring agency in meeting the three challenges cited above—ordered item booklets and a diagnostic pretest.

The materials are created using items that are representative of, and on the same scale as, a state assessment. Preferably, the materials are created using items released by the states from previous tests. Few states presently release forms of the test because (a) tests are expensive to construct and releasing items increases development costs, and (b) a common psychometric equating design to provide comparable results from year to year involves retaining common (secure) items on tests from year to year; however, a sufficient number of items are released by some states to prepare the materials needed to practice the invention. As new items are released, they can be combined with the previous version of the materials to provide an updated, more useful product.

The materials are essentially a released, calibrated, alternate form of the state assessment. This released form is assembled into an ordered item booklet, similar to what is used at standard setting in that items are presented in order of difficulty; however, the items are already sectioned by performance level (e.g., partially proficient, proficient, advanced), and certain information (such as content standard measured, distracter analysis, P-values) is provided for each item. These ordered item booklets are studied by teachers to gain an understanding of what the test measures as well as to communicate the expectations for student performance in each performance level.

The same items from the ordered item booklets can be re-packaged as a diagnostic pre-test or pre-assessment for administration earlier in the school year than the state assessment, or in the off-grades. The teacher determines students' current performance level from the results of the pre-assessment and uses this information to determine appropriate instructional activities.

### BRIEF DESCRIPTION OF THE DRAWINGS

FIG. 1 shows a sample of a test page from an ordered item booklet of a type used in the Bookmark™ standard setting process.

FIG. 2 shows an ordered item booklet of the type used as part of the system and method of the present invention.

FIG. 3 shows an item map page that may be included in an ordered item booklet according to the present invention.

FIG. 4 shows a flow chart illustrating an embodiment of the method of the present invention.

FIG. 5 shows a number correct to performance level correlation table.

### DETAILED DESCRIPTION OF THE PREFERRED EMBODIMENT

A method of linking content standards, curriculum, instruction and assessment according to the present invention utilizes at least one ordered item booklet and at least one of a user's guide for the ordered item booklet, a diagnostic pre-test booklet, a scoring guide for the diagnostic pre-test booklet (e.g., including number correct to performance level tables), and a user's guide for the diagnostic pre-test booklet. The method may also utilize an optional video tape created at an optional training conference.

Ordered item booklets are typically assembled using all items on which the standards are to be based, in order of scale location/item difficulty. Each ordered item booklet is preferably directed to a specific subject or content area (e.g., math or reading); however, multiple subjects can be incorporated within a single booklet as different sections of ordered items if desired. The ordered item booklet focuses the participants' attention on one item per page, with the “easiest” item (lowest scale location) first and the “hardest” item (highest scale location) last. The purpose of the ordered item booklets is to help participants foster an integrated conceptualization of what the test measures, to familiarize the participants with the assessment items and the knowledge, skills, and abilities students must have to be successful on the assessment, and to serve as a vehicle to make cut score judgments. Studying the items one by one, from easiest to hardest, discussing what each item measures and why each item is more difficult than items that precede it in the book, is intended to provide participants with an understanding of how the trait increases in complexity as the items ascend the scale, and of the knowledge, skills, and abilities students must have in order to respond successfully to items.

The items used in the ordered item booklets can be items from single or multiple forms of an operational test (i.e., a state assessment) or items on a common scale from an item pool that is representative in content and difficulty of a single form of the operational test. The use of items beyond those of a single operational form is recommended when possible, to increase the generalizability of the standards to other forms to which the standards may be applied in future years.

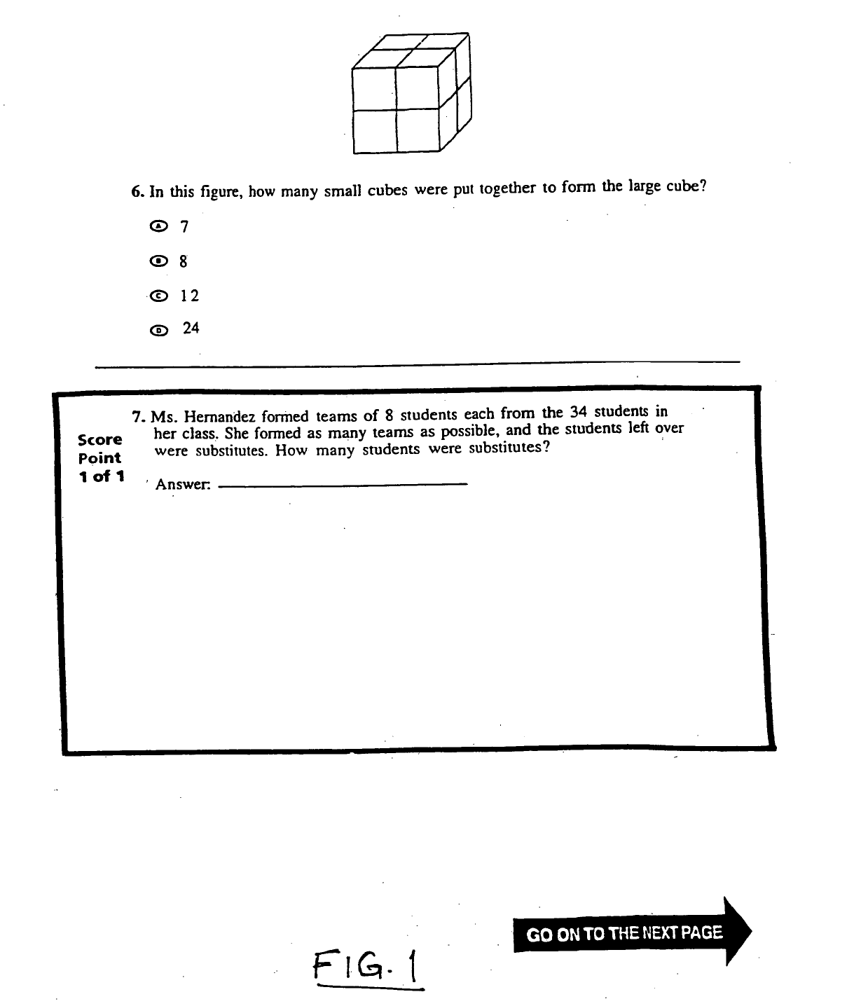

The ordered item booklets can be prepared (1) electronically or (2) by a cut-and-paste method. If the electronic file for the items is available, the ordered item booklet is preferably prepared electronically (e.g., using commercially available software such as Pagemaker®). Each item selected to be included in the ordered item booklet is preferably presented boxed (e.g., as shown in FIG. 1). This requires multiple copies of a page, one copy for each item used. In one embodiment, 6-point lines are used for the boxes. If an ordered item booklet is prepared by a cut-and-paste method, the items are boxed using a black graphic charting tape (e.g., 1/16^{th} inch black tape). Alternatively, each item can be presented independently on a single page without any other items appearing on the page.

If an item is a multiple-choice item, that's all that is done with it (unless it needs stimulus information as described in the next paragraph). If an item is a constructed-response item, a copy of the item is made for each score point, and the score point information is provided adjacent the item number. In other words, a constructed-response item may be reproduced a number of times equal to the number of possible scores. Thus, for a three-point item, the item may be reproduced three times, with three different sample answers representing scores of one point, two points and three points, respectively, each point representing a different degree of difficulty. That is, achieving a score of 3 is more difficult than achieving a score of 2 which is more difficult than achieving a score of 1. The item for the first score point may be labeled as “score point 1 of 3” with subsequent score point items having a similar format (i.e., Score Point 2 of 3, etc.).

The three score points of the constructed response would typically not appear as consecutive items in the ordered item booklet, because, for example, a score of ⅔ would not be the next most difficult item, among the entire collection of items, compared to a score of ⅓.

In addition, if several items are dependent on the same stimulus (i.e., depend on a passage, poem, chart, graph, etc.) stimulus information may be provided on the page, e.g., at the top left of the page in the following format:

The Gardener (see passage A)

The stimuli are preferably lettered alphabetically and placed in alphabetical order at the front of the ordered item booklet. A table of contents may be added listing the stimuli and their corresponding letters. The use of stimuli usually applies to reading/language arts items but there may be such dependency in social studies, math, science, or any content area.

The order of difficulty numbers are preferably added in the upper right comer electronically or using the overlay feature on the copy machine if using the cut-and-paste method.

Once this information is added to the items, the pages are proofread against the test books to check that nothing has dropped out, been reformatted, or changed at a later stage and to check that the stimuli references are correct.

Scoring rubrics or rules can be incorporated in the ordered item booklets or provided in a separate booklet. The rubric pages are preferably numbered with the order of difficulty numbers followed by an r (for rubric) in the upper right corner. The easiest way to put these numbers on the rubric pages is to print them and use the overlay feature on a more advanced copy machine to put them on the rubric pages. Multiple-choice items do not have rubrics, so only the order of difficulty numbers for the constructed-response items need to be printed out and overlaid onto the rubric pages.

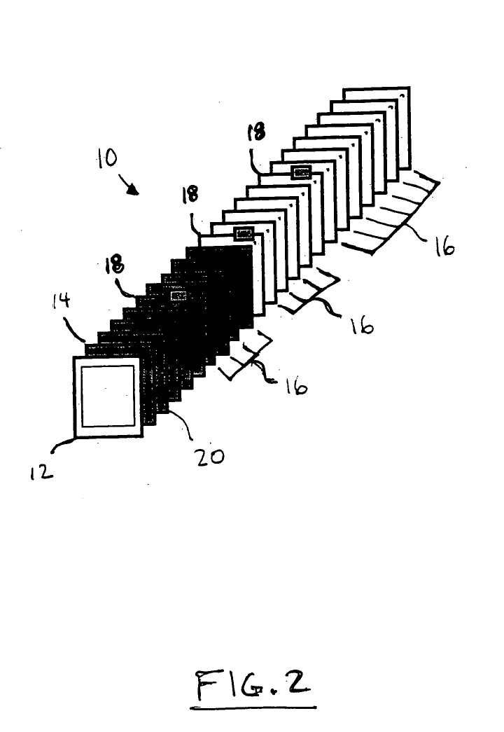

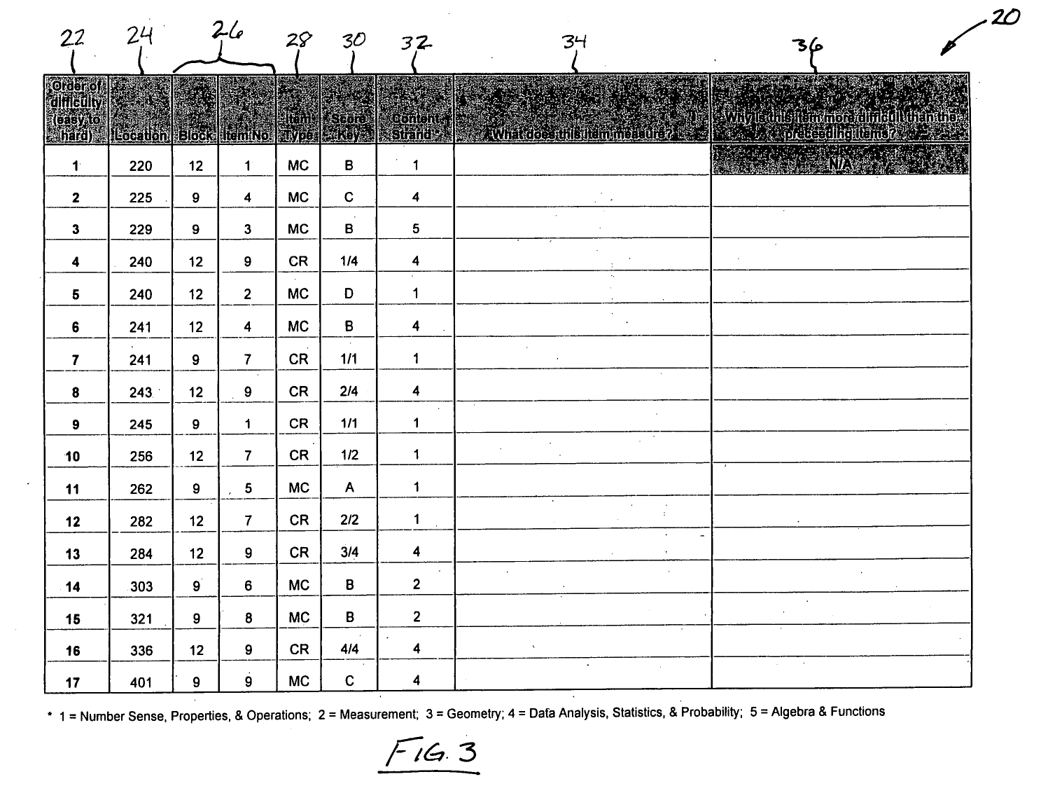

As shown in FIG. 2, an ordered item booklet 10 preferably includes a cover 12, a table of contents 14, item pages 16 in numerical order (with constructed-response items being followed by their respective rubric pages), and tabbed dividers 18 separating items associated with the different performance levels (e.g., partially proficient, proficient and advanced). The booklets may also include an item map 20, for example as shown in FIG. 3, listing each item 22 in order of difficulty, its location 24 on a scale of difficulty in quantitative or absolute terms (e.g., the point on the test scale where a student would have a ⅔ likelihood of answering the question correctly), the origin of the item 26 (if applicable), the type of item 28 (e.g., multiple choice “MC” or constructed response “CR”), a score key 30 (i.e., the multiple choice answer or constructed response score point illustrated), content strand 32 (i.e., corresponding standard or objective), and space for teacher notes. The item map page 20 may also indicate in which broad performance level (e.g., partially proficient, proficient or advanced) an item is classified. Item map 20 may also include blank spaces for use during training conferences, in which participants can fill in skills each item is intended to measure 34 and why each item is more difficult than the item that preceded it 36.

Information about an item can also be provided on the same page as the item (particularly if the item is presented independently of other items) or on the page facing the item. One or more of the following types of information can be provided:

Performance level association

Item analyses, that is, p-value, distracter analysis, point-biserial correlations

the item's scale location

the item number in the operational or field test booklet

the item type (multiple choice MC or constructed response CR)

the score key (for MC the number indicates the position—A, B, C, or D—of the correct response;

for constructed response items, an indication of the score point, e.g., ½ indicates the first score point of 2

the standard or objective the item was written to measure

space for the user to make notes about the items.

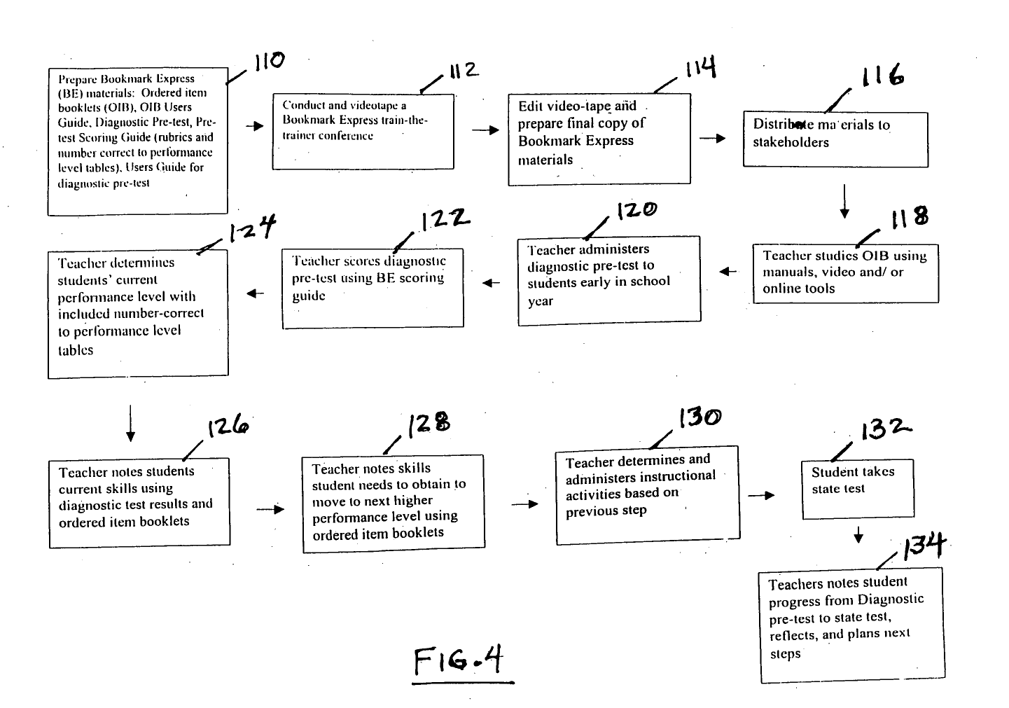

FIG. 4 is a flow chart illustrating the method according to one embodiment of the present invention. In step 110, the materials used in performing the method are prepared. These materials preferably include ordered item booklets, a diagnostic pre-test, a pre-test scoring guide, and user's guides for the ordered item booklets and the pre-test. In step 112, which is an optional step, expert teachers are assembled for a “train-the-trainer” conference that is conducted using the materials prepared in step 110.

During the conference, the participants (typically teachers) study the ordered item booklets in terms of what the test is measuring and what is expected of students in each performance level. Note that this assumes a standard setting has already occurred as reflected by placement of the dividers 18 in the ordered item booklet.

The conference participants discuss the items one by one, in order of difficulty, focusing on the following questions:

What does each item measure? How does it relate to the curriculum and state content standards?

Why is each item more difficult than the items that precede it?

Are students expected to master the item to be Basic? Proficient? Advanced?

How do the “Proficient” items relate to the Proficient performance level descriptors? “Advanced” items? etc.

The conversations at several of the tables are preferably videotaped.

When the participants complete the conference they should understand:

What the test measures relative to the state content standards and curriculum.

What the expectations for students are in each performance level.

What skills a student would need to attain to move from one performance level to the next higher one.

The videotape and materials may be edited at step 114 in accordance with the discussions that occurred during the conference 112. Such editing may include revising the information that is provided about certain items and may, but typically would not, include re-ordering of certain items in the ordered item booklet. The materials are then distributed to stakeholders at step 116 so that teachers can undergo the same experience at their own school (for required professional development credit if possible). If the optional conference 112 is omitted, the process according to the present invention progresses directly from step 110 to step 116. The videotape and materials can be distributed physically or electronically (e.g., via one or more electronic computer files or the internet). Teachers study the ordered item booklets in step 118. This could be done with one of the trainers that attended the workshop, or individually, or online.

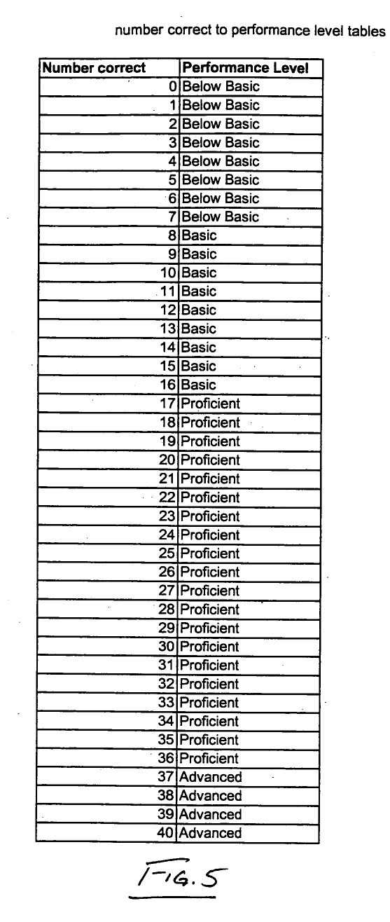

As mentioned above, the same items from the ordered item booklets are re-packaged in the diagnostic pre-test. Re-packaging includes putting the items back into a normal test order. That is, the items are taken out of the ascending order of difficulty of the ordered item booklet. Also, duplicate copies of a constructed response item, which appear in the ordered item booklets a number of times in accordance with the possible number of score points, are removed. At step 120, the diagnostic pre-test is administered to students, preferably earlier in the school year than the state assessment, or at the same time as the state assessment in the off-grades. The teacher scores the diagnostic test at step 122 using the pre-test scoring guide. (The open-ended items could optionally be scored by the test publisher with trained readers. The open-ended items could be electronically scored if the student takes a computer-based version of the pre-test.) The teacher determines the students' current performance levels at step 124 using raw score to performance level correlation tables (See, e.g., FIG. 5.) that are provided with the materials and notes the students' current skills using the diagnostic test results and the ordered item booklets at step 126. That is, based on the performance level achieved by the student on the diagnostic pretest, the teacher can assess, using the ordered item booklet, the skills the student has which correspond to the performance level achieved. Once the teacher has identified the current performance level, they may look to items in the next performance level in the ordered item booklet at step 128 to note which skills a student needs to obtain to move to the next higher performance level. The teacher may then determine and administer appropriate instructional materials in step 130. Note that teachers, having studied the items in the diagnostic pre-test in the form of the ordered item booklets, have a strong understanding of what the items measure and how they relate to the curriculum and the state content standards. When they examine the items students responded to correctly and those they missed, they can draw on this knowledge to attain insight into the students' strengths and weaknesses. The knowledge provided by studying the ordered item booklet will be a powerful tool for the teachers to use in creating prescriptive instruction and designing additional instructional activities for students.

Following instruction, the student takes the state assessment at step 132 and the teacher notes student progress relative to the diagnostic pre-test at step 134.

The primary value of the present invention is the unique capability to meet three public relations challenges that are commonly faced by state departments of education.

The first, communicating how and what the state test measures to stakeholders (parents, teachers, students, school administrators, the business community, etc.), is met by providing released test items and a formal activity to study the items that increases stakeholders' understanding of what the test is measuring.

The second, communicating to stakeholders the meaning and nature of the performance levels set on a state assessment through a state sponsored standard setting process, is met by presenting the items in order of difficulty and grouped by performance level. Stakeholders can study all the items that students in a given performance level are expected to master. This provides a means for stakeholders to understand the unique skills expected of students in each performance level. Teachers and parents can use the invention to better understand a students' current level of achievement by studying the items associated with the student's performance level. Teachers and parents can also use the invention to better understand the knowledge and skills a student needs to attain in order move into a higher performance level by studying the items associated with the performance level immediately above the student's current level of achievement.

The third, supporting teachers with useful tools in their mission to foster student growth as measured by the state test and performance levels, is met by use of the diagnostic pre-test to assess students' level of achievement early in the school year. By self-scoring the test using the scoring guide included with the materials, the parent or teacher can understand the student's current level of achievement so that appropriate instructional activities can be provided to the student. That is, (a) the student is administered the diagnostic pre-test early in the school year, (b) the administrator scores the student's work using the tools provided with the materials, (c) the student's current performance level is obtained using the number correct to performance level tables provided with the materials, (d) the parent or teacher studies the items associated with the given performance level to better understand the student's current skill set and (e) studies the skills required of items in the next higher performance level to include in the instructional activities being planned for the student to help the student move to the next higher performance level.

Teachers and other education professionals typically have to obtain a specified number of professional development credits to remain certified. The activities provided by this invention could be authorized by a state department of education as fulfilling some of these professional development credits. For example, workshops could be held to train educators in the use of the materials over a two or three day period, or individual teachers could be trained to use the materials alone or in small groups using the instructional guides and/or optional videotapes.

The materials used in performing the above method can be provided online (i.e., via a distributed computer network). Online materials would allow moderators to conduct sessions (studying ordered item booklets and holding discussion groups) for parents, teachers, and other stakeholders in remote locations, or for those from smaller schools where the number of teachers in a given grade/content area is limited, or for those who could not attend the train-the-trainer conference.

While the invention has been described in detail above, the invention is not intended to be limited to the specific embodiments as described. It is evident that those skilled in the art may now make numerous uses and modifications of and departures from the specific embodiments described herein without departing from the inventive concepts.

What is claimed is:

1. An automated method of instruction and assessment comprising:
providing an electronic form of a set of ordered assessment items comprising a collection of assessment items arranged in ascending order by degree of difficulty from least difficult to most difficult or in descending order of difficulty from most difficult to least difficult and one or more cut-off indicators corresponding to one or more associated performance levels;
administering a computer-based version of a pre-test comprising assessment items from the set of ordered assessment items via a computer network;
electronically scoring the pretest to determine an achieved score;
correlating the achieved score with a one of the associated performance levels to assess a performance level of the test-taker; and
comparing the test-taker's performance level as demonstrated by the achieved score of the pre-test with the set of ordered items to determine additional skills that must be attained to achieve a level of performance that is higher than that which was demonstrated by the achieved score of the pre-test.

2. The method of claim 1, further comprising defining and administering instructional activities correlated to the additional skills that must be achieved.

3. The method of claim 1, wherein electronically providing the set of ordered assessment items comprises collecting assessment items released by states from previous assessments.

4. The method of claim 1, further comprising providing additional information about one or more of the items of the set of ordered assessment items, said additional information comprising one or more items of information selected from the group comprising: performance level association, p-value, distracter analysis, point-biserial correlations, and scale location.

5. The method of claim 1, further comprising providing a correlation chart for correlating the achieved score with a one of the associated performance levels to assess a performance level of the test-taker.

6. The method of claim 1, wherein the set of ordered assessment items is arranged in ascending order of difficulty, and achievement of a specified performance level requires the ability to provide a correct response to substantially all of the assessment items preceding a cut-off corresponding to the specified performance level.

7. The method of claim 2, further comprising administering a test subsequent to administering said instructional activities to assess whether the test-taker has achieved a performance level higher than that achieved on the pre-test.

8. An automated method of instruction and assessment comprising:
developing an electronic collection of assessment items arranged in an ascending order of difficulty;
identifying one or more cutoffs within the collection of assessment items corresponding to one or more respective performance levels, wherein achievement of a specified performance level requires the ability to provide a correct response to substantially all of the assessment items preceding a cut-off corresponding to the specified performance level;
administering as a computer-based diagnostic assessment at least a portion of the assessment items included within the collection of assessment items to a test-taker via a computer network;
correlating the test-taker's score on the diagnostic assessment with a performance level;
identifying from the collection of assessment items, and based on the performance level achieved by the test-taker on the diagnostic assessment, the current skills possessed by the test-taker; and
identifying from the collection of ordered assessment items, the additional skills the test-taker must obtain in order to achieve a level of performance level that is higher than that achieved on the diagnostic assessment.

9. The method of claim 8, wherein developing a collection of assessment items comprises collecting assessment items released by states from previous assessments.

10. The method of claim 8, further comprising providing additional information about one or more of the items of the collection of assessment items, said additional information comprising one or more items of information selected from the group comprising: performance level association, p-value, distracter analysis, point-biserial correlations, and scale location.

11. The method of claim 8, further comprising providing a correlation chart for correlating the test-taker's score on the diagnostic assessment with a performance level.

12. The method of claim 8, further comprising defining and administering instructional activities correlated to the additional skills that must be obtained.

13. The method of claim 12, further comprising administering an assessment subsequent to administering said instructional activities to assess whether the test-taker has achieved a performance level higher than that achieved on the diagnostic assessment.

14. An automated system of instruction and assessment comprising:
an electronic collection of assessment items arranged in an ascending or descending order of difficulty and including one or more cutoffs within the collection of assessment items corresponding to one or more respective performance levels, wherein achievement of a specified performance level in a collection of assessment items arranged in ascending order of difficulty requires the ability to provide a correct response to substantially all of the assessment items preceding a cut-off corresponding to the specified performance level, and achievement of a specified performance level in a collection of assessment items arranged in descending order of difficulty requires the ability to provide a correct response to substantially all of the assessment items following a cut-off corresponding to the specified performance level;
a computer-based diagnostic assessment including at least a portion of the assessment items included within the collection of assessment items; and
a correlation chart for correlating a test-taker's score on the diagnostic assessment with a performance level.

15. The system of claim 14, wherein said collection of assessment items comprises assessment items released by states from previous assessments.

16. The system of claim 14, said collection of assessment items further including additional information about one or more of the items, said additional information comprising one or more items of information selected from the group comprising: performance level association, p-value, distracter analysis, point-biserial correlations, and scale location.
